(19) United States
(12) Patent Application Publication
(10) Pub. No.: US 2005/0108246 A1
(43) Pub. Date: May 19, 2005

(54) Systems and methods for accelerating data retrieval

(76) Inventor: Doug Dillon, Gaithersburg, MD (US)

Correspondence Address: THE DIRECTV GROUP, INC.;RE/R11/A109, P.O. Box 956, El Segundo, CA, 90245-0956, US

(21) Appl. No.: 10/873,993

(22) Filed: Jun. 22, 2004

Related U.S. Application Data
(60) Provisional application No. 60/516,464, filed on Oct. 31, 2003.

(51) Int. Cl. G06F 7/00

(52) U.S. Cl. 707/10

(57) ABSTRACT

A system for retrieving data includes a transmitter, a receiver and logic. The logic receives a command from a client for retrieving data stored on a server. The logic transmits the first command to the server via the transmitter. The logic also transmits at least one additional command to the server without additional input from the client, where the additional command is based on the first command.

### RELATED APPLICATIONS

This application claims priority under 35 U.S.C. § 119 based on U.S. Provisional Application Ser. No. 60/516,464, filed Oct. 31, 2003, the disclosure of which is hereby incorporated herein by reference.

### BACKGROUND OF THE INVENTION

1. Field of the Invention

The present invention relates generally to data retrieval and, more particularly, to accelerating the retrieval of data over relatively long latency links.

2. Description of Related Art

Satellite communications systems are currently being used to transmit and receive conventional Internet Protocol (IP) data. In such systems, remote terminals communicate with a hub or server via one or more satellites to access the Internet, send and retrieve electronic mail (email) messages, etc.

As users' demands for increased data throughput and reduced processing time continue to increase, new ways of retrieving data via relatively long latency links, such as satellite links, are needed. Therefore, a need exists for systems and methods that provide new ways to retrieve data to reduce latency.

### SUMMARY OF THE INVENTION

Systems and methods consistent with the present invention address these and other needs by anticipating commands to accelerate the retrieval of data.

In accordance with the principles of the invention as embodied and broadly described herein, a system that includes at least one logic device is provided. The logic device is configured to receive a first command from a client for retrieving an email message stored on a server and transmit the first command to the server. The logic device is also configured to transmit at least one additional command to the server, where the at least one additional command is transmitted without additional input from the client and is based on the first command.

In another implementation consistent with the present invention, a method for retrieving data is provided. The method includes receiving a first command from an email client and transmitting the first command to a server. The method also includes transmitting at least one additional command to the server without additional input from the email client, where the at least one additional command comprises a command expected to be received from the email client.

In still another implementation consistent with the present invention, a computer-readable medium having stored instructions is provided. The instructions, when executed by at least one processor, cause the processor to receive a first command from a client, where the first command is associated with accessing email messages stored on a server. The instructions also cause the processor to transmit the first command to the server and transmit at least one additional command to the server. The at least one additional command is based on the first command and is transmitted without additional input from the client. The at least one additional command is also transmitted prior to receiving a response to the first command.

In still another implementation consistent with the present invention, a terminal device configured to transmit and receive data via satellite is provided. The terminal device includes a memory configured to store data and at least one logic device. The logic device is configured to receive a first command from a client for retrieving data and transmit the first command to a server via satellite. The logic device is also configured to transmit at least one additional command to the server via satellite, where the additional command is based on the first command and is transmitted without further input from the client. The logic device is further configured to receive a response to the first command via satellite, forward the response to the client, receive a response to the additional command via satellite and buffer the response to the additional command. The logic device is also configured to forward the buffered response to the additional command to the client in response to receiving a command from the client corresponding to the additional command.

In a further implementation consistent with the present invention, a satellite terminal is provided. The satellite terminal includes a switch configured to receive a command associated with email retrieval and redirect the command. The satellite terminal also includes an email retrieval proxy configured to receive the redirected command and forward the redirected command to an email server.

### BRIEF DESCRIPTION OF THE DRAWINGS

The accompanying drawings, which are incorporated in and constitute a part of this specification, illustrate the invention and, together with the description, explain the invention. In the drawings,

FIG. 1 is a diagram of an exemplary network in which systems and methods consistent with the present invention may be implemented;

FIG. 2 is a diagram of an exemplary terminal of FIG. 1 in an implementation consistent with the present invention;

FIGS. 3A-3C are exemplary functional block diagrams of systems consistent with the present invention;

FIG. 4 is a flow diagram illustrating exemplary processing associated with the retrieval of data by the terminal of FIG. 1 in an implementation consistent with the present invention; and

FIG. 5 is an exemplary finite state machine diagram illustrating exemplary processing by the POP proxy in an implementation consistent with the present invention.

### DETAILED DESCRIPTION

The following detailed description of the invention refers to the accompanying drawings. The same reference numbers in different drawings may identify the same or similar elements. Also, the following detailed description does not limit the invention. Instead, the scope of the invention is defined by the appended claims and equivalents.

Systems, devices and methods consistent with the present invention accelerate the retrieval of data over long latency links, such as satellite links, by anticipating commands expected to be performed. Data may then be retrieved based on the expected commands. The retrieved data may be stored and forwarded to a client when the expected command is performed.

### Exemplary Network

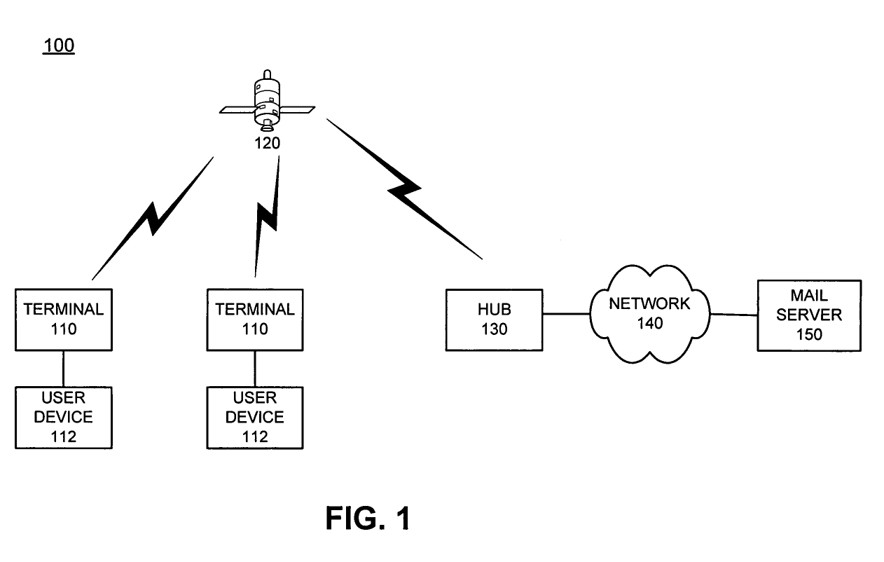

FIG. 1 illustrates an exemplary network in which methods, devices and systems consistent with the present invention may be implemented. Network 100 includes a number of terminals 110, user devices 112, a satellite 120, hub 130 (also referred to as access earth station 130) network 140 and a mail server 150. The number of components illustrated in FIG. 1 is provided for simplicity. It will be appreciated that a typical network 100 may include more or fewer components than are illustrated in FIG. 1.

Terminals 110 transmit and receive information over an air/free space interface to/from satellite 120. Terminals 110 may interface with user devices 112 to provide users with broadband IP communication services. User devices 112 may include personal computers (PCs), lap top computers, personal digital assistants (PDAs), wireless telephones, etc., that are able to execute conventional programs, such as email programs. Terminals 110 may directly connect to a user device 112 via, for example, a universal serial bus (USB). Terminals 110 may also connect to user devices 112 via a local area network (LAN) interface, such as an Ethernet interface or wireless Ethernet interface. Alternatively, terminal 110 and user device 112 may be implemented in a single device/system that is capable of performing both the functions of terminal 110 and user device 112.

Satellite 120 may support two-way communications with earth-based stations, such as terminals 110 and access earth station 130. Satellite 120 may include one or more uplink antennas and one or more downlink antennas for receiving data from and transmitting data to terminals 110 and access earth station 130. For example, satellite 120 may receive data transmitted from terminal 110 or access earth station 130 in the C-band, Ku-band, Ka-band, X-band, L-band or other frequency bands. Satellite 120 may also include transmit circuitry to permit satellite 120 to use the downlink antenna(s) to transmit data using various ranges of frequencies. For example, satellite 120 may transmit data in any of the above frequency bands (i.e., C-band, Ku-band, Ka-band, X-band, L-band) or in other frequency bands.

Access earth station 130 may support network access for a large number of terminals 110 via satellite 120. Access earth station 130 may access space segment resources from multiple satellites 120 and manage such resources. A network operations center (not shown) may manage network 100, including access earth station 130. For example, a network operations center may receive data from terminals 110 via access earth station 130 and determine the appropriate power levels associated with transmitting data to terminals 110. Access earth station 130 may then transmit uplink information to satellite 120 regarding downlink power control.

Backend systems (not shown) may interface with access earth station 130 and include routers, firewalls, etc. to provide the interface between network 100 and an external public network, e.g., the Internet.

Network 140 may include one or more networks, such as the Internet, an intranet, a wide area network (WAN), a LAN, or another type of network that is capable of transmitting data from a source device to a destination device.

Mail server 150 may represent a mail server operating according to a conventional post office protocol (POP), such as the POP3 client/server protocol defined by Internet Engineering Task Force (IETF) Request for Comments (RFC) 1725. That is, mail server 150 may be a conventional POP3 server used for email-related services, such as email storage and retrieval by client devices executing any conventional email program. One of ordinary skill in the art will recognize that other email protocols may be used. Network 100 is described above with a user device 112 accessing mail server 150 via access earth station 130. It should also be understood that in other implementations, such as a mesh satellite network, user device 112 may access mail server 150 via another terminal 110, and not via a central access earth station 130.

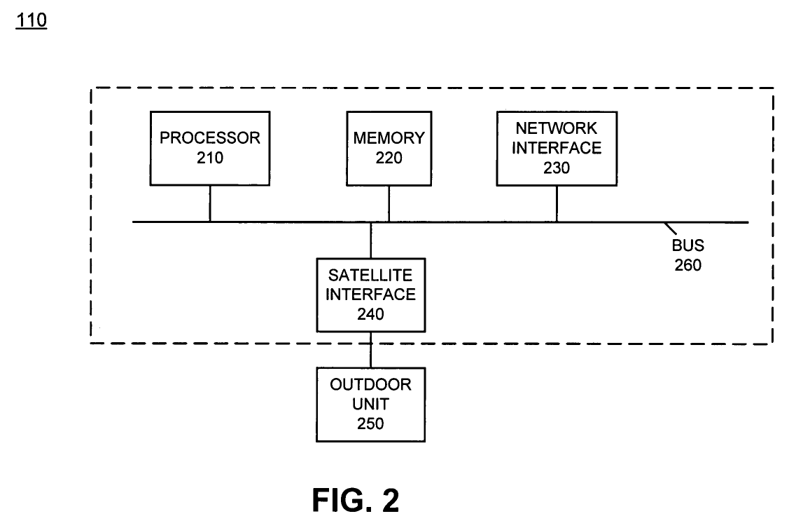

FIG. 2 illustrates an exemplary configuration of a terminal 110 consistent with the present invention. Referring to FIG. 2, terminal 110 includes processor 210, memory 220, network interface 230, satellite interface 240, outdoor unit 250 and bus 260. The elements shown in FIG. 2 within the dotted box (i.e., processor 210, memory 220, network interface 230, satellite interface 240 and bus 260) may represent elements of terminal 110 located indoors. In other implementations, one or more of these elements may be located outdoors.

Processor 210 may include any type of conventional processor or microprocessor that interprets and executes instructions. Processor 210 may perform data processing functions relating to transmitting data from terminal 110 to access earth station 130.

Memory 220 may provide permanent, semi-permanent, or temporary working storage of data and instructions for use by processor 210 in performing processing functions. Memory 220 may include a conventional random access memory (RAM) or another dynamic storage device that stores information and instructions for execution by processor 210. Memory 220 may also include a conventional read only memory (ROM), an electrically erasable programmable read only memory (EEPROM) or another static or non-volatile storage device that stores instructions and information for use by processor 210. Memory 220 may further include a large-capacity storage device, such as a magnetic and/or optical recording medium and its corresponding drive.

Network interface 230 may include an interface that allows terminal 110 to be coupled to a user device 112, such as a PC, a laptop computer, a PDA, a wireless device, etc. Network interface 230 may also include an interface that allows terminal to be coupled to an external network. For example, network interface 230 may include a USB interface, an Ethernet interface or wireless Ethernet interface for communicating via a LAN, an asynchronous transfer mode (ATM) network interface and/or an interface to a cable network. Alternatively, network interface 230 may include other mechanisms for communicating with other devices and/or systems.

Satellite interface 240 may include an interface that allows terminal 110 to communicate with satellite 120. For example, satellite interface 240 may provide an interface for forwarding data to/receiving data from outdoor unit 250. Satellite interface 240 may also include one or more logic devices, such as application specific integrated circuits (ASICs), that control the operation of terminal 110.

For example, satellite interface 240 may include conventional modulator/demodulator circuitry that combines data signals with carrier signals via modulation and extracts data signals from carrier signals via demodulation. Satellite interface 240 may also include conventional components that convert analog signals to digital signals, and vice versa, for communicating with other devices in terminal 110. Satellite interface 240 may further include conventional circuitry, such as oscillators and counters, for performing timing-related operations associated with one or more functions performed by terminal 110.

Outdoor unit 250 may include one or more conventional antennas capable of transmitting/receiving signals via radio waves. Outdoor unit 250 may also include conventional transmitter/receiver circuitry for transmitting and/or receiving data via satellite 120. For example, outdoor unit 250 may include an antenna and circuitry capable of transmitting/receiving data in the C-band, Ku-band, Ka-band, X-band, L-band or other frequency bands.

Bus 260 may include one or more conventional buses that interconnect the various components of terminal 110 to permit the components to communicate with one another. The configuration of terminal 110, shown in FIG. 2, is provided for illustrative purposes only. One skilled in the art will recognize that other configurations may be employed. Moreover, one skilled in the art will appreciate that a typical terminal 110 may include other devices that aid in the reception, transmission, or processing of data. It should also be understood that various components of terminal 110 may be located remotely from each other. For example, outdoor unit 250 may be located outdoors, while other elements in terminal 110 may be located indoors.

Terminal 110, consistent with the present invention, performs processing associated with retrieving IP data, such as email messages, via satellite 120. Terminal 110 may perform such processing, described in detail below, in response to processor 210 executing sequences of instructions contained in a computer-readable medium, such as memory 220. It should be understood that a computer-readable medium may include one or more memory devices and/or carrier waves. The instructions may be read into memory 220 from another computer-readable medium or from a separate device via network interface 230. Execution of the sequences of instructions contained in memory 220 causes processor 210 to perform the process steps that will be described hereafter. In alternative implementations, hard-wired circuitry may be used in place of, or in combination with, software instructions to implement the present invention. For example, satellite interface 240 and/or other devices may perform one or more of the acts described below. In still other alternatives, various acts may be performed manually, without the use of terminal 110. Thus, the present invention is not limited to any specific combination of hardware circuitry and software.

Terminals 110, as discussed above, may retrieve email messages from mail server 150 for reading via user devices 112. In an exemplary implementation, terminals 110 may anticipate expected commands from an email client and pre-fetch data corresponding to the expected commands. Terminals 110 may cache this data until the expected command is actually performed. At this point, the cached data may be forwarded to the email client, as described in more detail below.

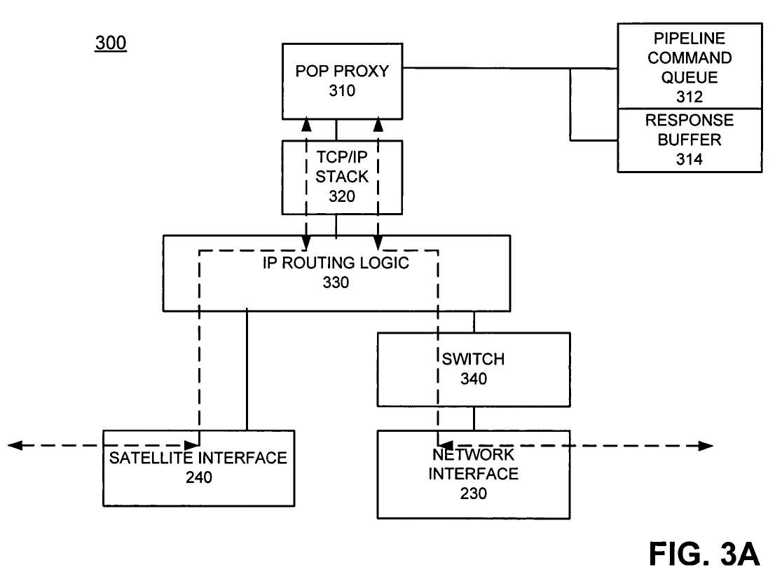

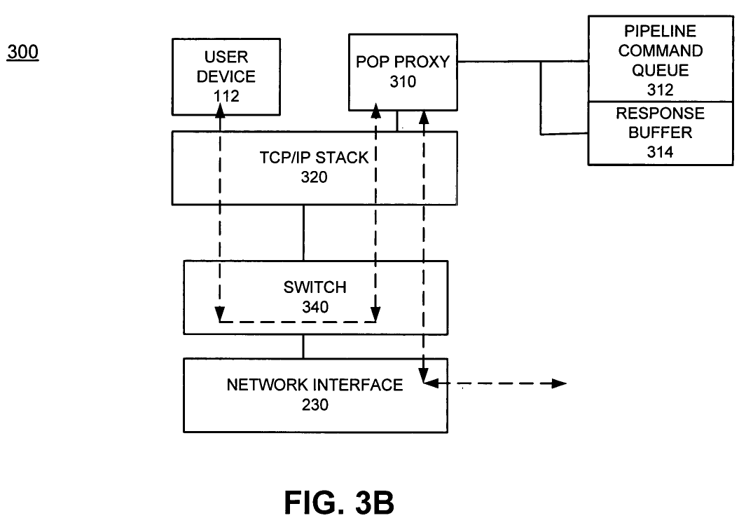

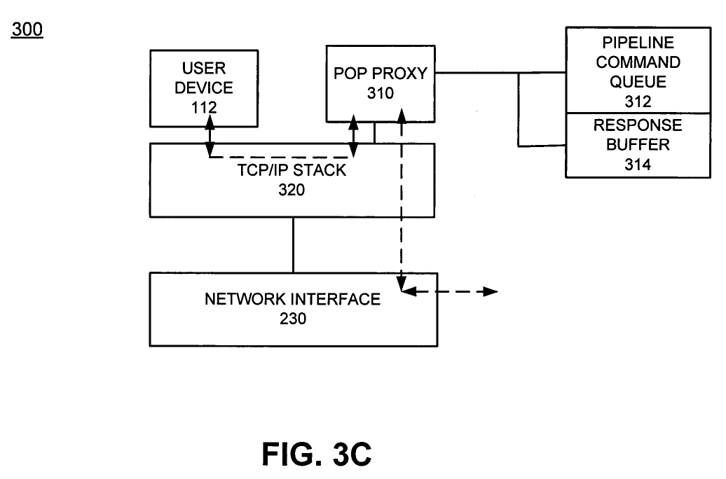

FIG. 3A illustrates an exemplary functional diagram of a system 300 implemented in terminal 110 for accelerating the retrieval of data, consistent with the present invention. Referring to FIG. 3A, system 300 includes POP proxy 310, pipeline command queue 312, response buffer 314, transmission control protocol/Internet protocol (TCP/IP) stack 320, IP routing logic 330, switch 340, network interface 230 and satellite interface 240. The elements in FIG. 3A may be implemented in terminal 110 in hardware, software or any combination of hardware or software. For example, POP proxy 310 may be implemented by processor 210 (FIG. 2) performing instructions stored in memory 220.

POP proxy 310 accelerates the retrieval of data, such as email messages stored on a mail server, by anticipating expected commands. For example, terminal 110 may receive a TCP connection request from user device 112 via network interface 230. The TCP connection request may be associated with establishing a connection from user device 112 to mail server 150 to retrieve email messages. System 300 may redirect the TCP connection request through switch 340, IP routing logic 330 and TCP/IP stack 320 to POP proxy 310, as illustrated by the dotted lines in FIG. 3A. POP proxy 310 may then establish a TCP connection to mail server 150 via satellite interface 240, as indicated by the dotted lines in FIG. 3A. POP proxy 310 may then “pipeline” multiple commands for transmission to mail server 150, as described in more detail below. POP proxy 310 may also act to receive information from mail server 150 via satellite interface 240 and selectively forward the received data to user device 112, as described in more detail below.

Pipeline command queue 312 may store commands that have been transmitted to mail server 150. These pipelined commands correspond to commands that POP proxy 310 expects an email client to make. Response buffer 314 stores responses to the pipelined commands that have been transmitted to mail server 150. Response buffer 314 acts as a cache to temporarily store the responses from mail server 150 until the email client transmits one of the expected commands

TCP/IP stack 320 may include software and utilities that support TCP/IP processing for data which passes through terminal 110. IP routing logic 330 may perform IP related processing for data packets received by terminal 110. Switch 340 may include logic for making intelligent switching decisions for terminal 110. For example, switch 340 may forward data frames based on TCP port information and IP source/destination addresses. Switch 340 may also make its switching decisions in accordance with layer 4 information. Layer 4 refers to the transport layer in the open systems interconnection (OSI) reference model. The transport layer manages end-to-end control for data transfer between end points. It should be understood, however, that layer 4 may denote other equivalent protocols.

In an exemplary implementation, switch 340 may operate in accordance with TCP and user datagram protocol (UDP). As such, switch 340 may make switching decisions based on information in the transport layer of a data packet. Switch 340 may also perform error recovery and flow control for data packets transmitted to/received from network interface 230. The layer 4 switch function of switch 340, consistent with the invention, may be included in a LAN driver (e.g., an Ethernet driver). The layer 4 switch function may route domain name server lookups (i.e., Domain Name Service (DNS) requests) and HyperText Transfer Protocol (HTTP) requests traversing the driver up through TCP/IP stack 320 to, for example, POP proxy 310. The layer 4 switch function of switch 340 may identify the requests by examining the port number of the packets and modify the addresses and ports to redirect the request packets to the appropriate proxy (e.g., POP proxy 310). The layer 4 switch function may perform a similar function of modifying packet addresses and port fields of response packets to route those responses. To accomplish this, the layer 4 switch function of switch 340 may maintain a TCP connection control block.

Switch 340 is illustrated in FIG. 3A as being located between IP routing logic 330 and network interface 230. In other implementations, switch 340 may be located between IP routing logic 330 and satellite interface 240, or in other locations. Switch 340 may also redirect commands from an email client to POP proxy 310, as described in more detail below.

FIG. 3B illustrates an alternative implementation of system 300, in which POP proxy 310 and user device 112 are part of the same system or are located on the same device. In this case, one or more of the functions described above with respect to terminal 110 may be performed by system 300 in FIG. 3B. Referring to FIG. 31B, system 300 includes user device 112, POP proxy 310, pipeline command queue 312, response buffer 314, TCP/IP stack 320, switch 340 and network interface 230. In this implementation, a TCP connection request from an email program being executed by user device 112 may be redirected to POP proxy 310 via TCP/IP stack 320 and switch 340, as illustrated by the dotted lines in FIG. 3B. The redirect may be performed in a transparent manner with respect to the email program. In other words, the email program may generate a conventional TCP connection request, which is then forwarded through TCP/IP stack 320 and switch 340 to POP proxy 310, as indicated by the dotted lines in FIG. 3B. POP proxy 310 may then forward the TCP connection request via network interface 230 to a terminal 110 (not shown), as indicated by the dotted lines in FIG. 3B. The terminal 110 may then transmit the TCP connection request via satellite 120. POP proxy 310 may also pipeline commands and selectively forward results to user device 112, as described in more detail below.

FIG. 3C illustrates another alternative implementation of system 300, in which POP proxy 310 and user device 112 are part of the same system or are located on the same device. In this case, one or more of the functions described above with respect to terminal 110 may be performed by system 300 in FIG. 3C. Referring to FIG. 3C, system 300 includes user device 112, POP proxy 310, pipeline command queue 312, response buffer 314, TCP/IP stack 320 and network interface 230. In this implementation, the TCP connection request from the email program being executed by user device 112 may be directed to POP proxy 310 in a non-transparent manner. In other words, the email program being executed by user device 112 may establish a connection with POP proxy 310 via TCP/IP stack 320, as indicated by the dotted lines in FIG. 3C. POP proxy 310 may then may then generate a TCP connection request and forward the request via network interface 230 to a terminal 110 (not shown), as indicated by the dotted lines in FIG. 3C. The terminal 110 may then transmit the TCP connection request via satellite 120. POP proxy 310 may also pipeline commands and selectively forward results to user device 112, as described in more detail below.

The operation of POP proxy 310 is described below with reference to POP3 protocol, such as POP3 protocol defined by IETF RFC 1725. It should be understood that POP proxy 310 may operate in accordance with other protocols. In the POP3 protocol, commands may include a single line ending with the carriage return and linefeed characters (CRLF). Responses in POP3 may include either a single line ending with CRLF or a multi-line response, where the last line is a period character (“.”) followed by CRLF. Responses may begin with either “+OK” (for command successfully executed) or “−ERR” (for command execution failure). For example, when a connection is first established with mail server 150, mail server 150 may send a Server Hello message, which is basically a +OK response line. After receiving the Server Hello message, the client commences with command/response transactions.

The following commands in POP3 will be described briefly below to facilitate a more complete understanding of the present invention.
1. USER—provides a user name to the server for account login.
2. PASS—provides a password to the server for account login.
3. STAT—provides overall statistics regarding the sum total of the messages in the server waiting to be retrieved.
4. LIST—provides a single line with the message number (an integer incrementing from 1) and the size in bytes of each message in the server waiting to be retrieved.
5. RETR—retrieves the designated message number from the server.
6. DELE—deletes the designated message number from the server.
7. XSENDER—a non-standard command used by the Netscape/Mozilla family of email clients. These clients accept the rejection of the XSENDER command and proceed with further email retrieval without further attempting the XSENDER command.
8. QUIT—ends the session.

As described with respect to FIGS. 3A-3 C, user device 112 may represent any conventional user/client device, such as a PC, laptop computer, PDA, wireless device, etc. that executes an email program. The email program may include email programs from Microsoft, such as Outlook or Outlook Express, Mozilla, Netscape, Eudora, etc. System 300 performs various functions associated with retrieving email messages and forwarding email messages to user device 112, as described in more detail below.

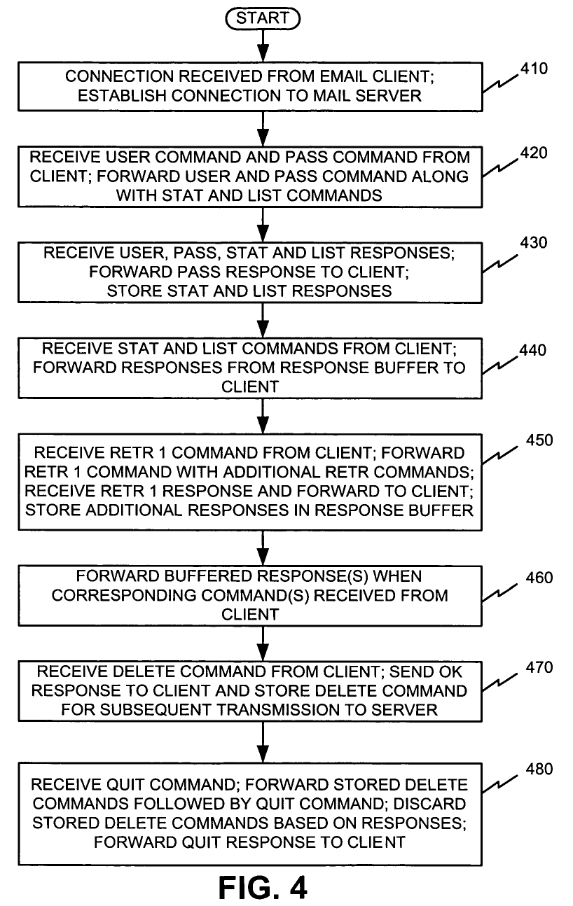

FIG. 4 illustrates an exemplary flow diagram associated with retrieving email via satellite 120 using exemplary system 300 illustrated in FIG. 3A. Similar processing may occur when using exemplary systems 300 illustrated in FIGS. 3B and 3C. In addition, error handling will not be described with respect to retrieving email messages in the following description for simplicity.

Assume that terminal 110 has already started up and has performed an initialization procedure with access earth station 130, i.e., performed timing synchronization, power control, etc. Further assume that an email program being executed by user device 112 (referred to hereafter as email client 112) has connected to terminal 110 and has made a request to access mail server 150 (act 410). Terminal 110 may then establish a connection to email client 112's email server, i.e., mail server 150 (act 410). As described previously with respect to FIG. 3A, system 300 implemented in terminal 110 may redirect the TCP connection request through switch 340, IP routing logic 330 and TCP/IP stack 320 to POP proxy 310, as illustrated by the dotted lines in FIG. 3A. POP proxy 310 may then establish a TCP connection to mail server 150 via satellite interface 240, as indicated by the dotted lines in FIG. 3A.

In some implementations, switch 340 may store the IP address of mail server 150 as the address of its connection peer. In this case, the outbound connection may include destination port information that switch 340 is configured to forward across the air/space link to mail server 150. In other implementations, the IP address of mail server 150 may be obtained from configuration parameters obtained from email client 112.

In either case, terminal 110 initiates a connection with mail server 150. The connection may be initiated from terminal 110 to mail server 150 via satellite 120 and access earth station 130. In an exemplary implementation, the connection may be a TCP connection. Access earth station 130 may identify the IP address of mail server 150 in the connection request and forward the connection request to mail server 150 via network 140. Mail server 150 receives the connection request from terminal 110 and upon the connection being established, forwards a greeting, such as a Server Hello message, to POP proxy 310. POP proxy 310 may then forward the greeting to email client 112.

Email client 112 may then forward the USER command, which is redirected by system 300 to POP proxy 310 (act 420). The USER command, as discussed above, provides a user name for logging into the user's email account. POP proxy 310 may immediately respond to the USER command from email client 112 with a +OK response and may temporarily store the USER command.

Email client 112 may then transmit the PASS command with the user's password to system 300, which redirects the PASS command to POP proxy 310 (act 420). POP proxy 310 may identify the PASS command and determine that the next likely commands transmitted by email client 112 will be the STAT and LIST commands. For example, POP3 proxy may store information indicating that after the PASS command is received, the STAT and LIST commands should follow. In other words, POP proxy 310 anticipates that a user, via email client 112, will wish to retrieve information regarding the total number of messages waiting to be retrieved (STAT) along with information providing the one line listing associated with the message (LIST) after logging on to the email account.

POP proxy 310 may then pipeline the STAT and LIST commands for transmission with the USER and PASS command (act 420). That is, POP proxy 310 may transmit the USER, PASS, STAT and LIST commands together, or in close time proximity to one another, to mail server 150. POP proxy 310 may also store the STAT and LIST commands in pipeline command queue 312. In this manner, POP proxy 310 may transmit anticipated commands without waiting for responses to commands that were actually received by POP proxy 310.

Assume that mail server 150 receives the USER, PASS, STAT and LIST commands from terminal 110. Mail server 150 may check the user name in the USER command and the password in the PASS command and respond with +OK responses, assuming the user name and password are valid. Mail server 150 may also provide responses to the STAT and LIST commands. The responses from mail server 150 are received by terminal 110, where they are directed to POP proxy 310. POP proxy 310 may receive the responses from the USER and PASS commands and forward the response for the PASS command to email client 112 (act 430). It should be noted that the response to the USER command will not be forwarded to email client 112 since POP proxy 310 previously provided a response to the USER command, as discussed above. POP proxy 310 may also receive the responses to the STAT and LIST commands and store these responses in response buffer 314 (act 430).

Assume that the next command from email client 112 is the STAT command. If the pipelined STAT command response has already been received from mail server 150, POP proxy 310 forwards the response stored in response buffer 314 to email client 112 (act 440). In the event that the STAT command response has not been received from mail server 150 when POP proxy 310 receives the STAT command from email client 112, POP proxy 310 waits until the response is received and forwards the STAT response to email client 112 when it is received. POP proxy 310, however, does not send the STAT command received from email client 112 to mail server 150, since this command was already sent with the USER and PASS commands.

Assume that the next command from email client 112 is the LIST command. POP proxy 310 holds the LIST command. If the pipelined LIST command response has already been received from mail server 150, POP proxy 310 forwards the LIST response from response buffer 314 to email client 112 (act 440). If the response has not already been received, POP proxy 310 waits until the response has been received and forwards the LIST response to email client 112 as soon as it is received from mail server 150. Once again, POP proxy 310 does not send the LIST command received from email client 112 to mail server 150, since the LIST command was already sent with the USER, PASS, and STAT commands.

In this manner, STAT and LIST commands are sent to mail server 150 prior to these commands being received from email client 112. The results are therefore received more quickly by POP proxy 310 and forwarded to email client 112 earlier than would be available using conventional processing.

POP proxy 310 may also pipeline RETR commands in a similar manner. For example, assume that POP proxy 310 receives the RETR 1 command from email client 112 (act 450). POP proxy 310 receives the RETR 1 command and identifies that the command is a command for retrieving an email message. POP proxy 310 anticipates that the user, via email client 112, will wish to retrieve additional email messages after retrieving the first email message. POP proxy 310 may then pipeline the RETR 1 command with additional RETR commands having incrementing message numbers. For example, POP proxy 310 may generate RETR 2 through RETR N commands, where N may be based on the response from the STAT command. That is, the STAT response from mail server 150 will indicate the number of email messages that are waiting to be retrieved from mail server 150. POP proxy 310 may read this number to determine the value of N. POP proxy 310 may then forward the RETR 2 through RETR N commands to mail server 150 along with the RETR 1 command (act 450). POP proxy 310 may also store the RETR 2 through RETR N commands in pipeline command queue 312.

As described above, POP proxy 310 may send the pipelined RETR commands until no additional messages are stored on mail server 150. Alternatively, POP proxy 310 may send a number of the additional RETR commands based on the size of response buffer 314. For example, based on the LIST command response, POP proxy 310 may determine the total number of response bytes associated with the emails stored on server 150. POP proxy 310 may then determine how many email messages to retrieve based on how many of these email messages can be stored in response buffer 314.

Mail server 150 receives the RETR commands (e.g., RETR 1 through RETR N) and provides responses to POP proxy 310. When POP proxy 310 receives the response to the RETR 1 command, POP proxy 310 forwards this response to email client 112 (act 450). POP proxy 310, however, may store the responses to the other RETR commands, such as the responses to the RETR 2 through RETR N commands, in response buffer 314 (act 450).

When email client 112 sends a RETR 2 command to POP proxy 310, POP proxy 310 checks response buffer 314 to determine whether a response to the RETR 2 has already been received. If so, POP proxy 310 forwards the response to the RETR 2 command from response buffer 314 to email client 112 (act 460). POP proxy 310 may also delete the RETR 2 command stored in pipeline command queue 312. Similar to the discussion above with respect to the STAT and LIST commands, POP proxy 310 does not send the actual RETR 2 command to mail server 150 when it is received, since POP proxy 310 previously transmitted this message to mail server 150 along with the RETR 1 command.

In a similar manner, when email client 112 transmits a RETR 3 command to POP proxy 310, POP proxy 310 searches response buffer 314 to determine whether a response to the RETR 3 command has already been received from mail server 150. If so, POP proxy 310 forwards the response to email client 112 and deletes the corresponding command from pipeline command queue 312 and the response from response buffer 314 (act 460). If not, POP proxy 310 waits until the response is received, forwards the response to email client 112 when it is received and deletes the corresponding command in pipeline command queue 312. In this manner, POP proxy 310 saves considerable time associated with retrieving email messages and forwarding them to email client 112.

This process may repeat until pipeline command queue 312 is empty and all the responses have been forwarded to email client 112. That is, POP proxy 310 waits for the next RETR command from email client 112 and either satisfies the command from response buffer 314 or waits until the response for the RETR command arrives and then satisfies the command. In either case, POP proxy 310 transmits commands expected to be performed by email client 112 prior to the actual receipt of the commands. POP proxy 310 may then cache the responses until the commands are actually received. It should also be understood that similar processing may occur if the first command from email client 112 for receiving an email message is not “RETR 1.” In other words, if the first command is RETR 5, POP proxy 310 may pipeline RETR 6 through RETR N, in addition to RETR 1 through RETR 4 commands. POP proxy 310 may then store the responses to the pipelined commands as described above.

POP proxy 310 may also pipeline DELE commands. For example, assume that a DELE 1 command has been received from mail server 150 (act 470). POP proxy 310 may immediately respond with a +OK response to email client 112 and store the DELE 1 command in pipeline command queue 312 for subsequent transmission to mail server 150 (act 470). When a next DELE command is received from email client 112, POP proxy 310 may similarly respond with a +OK response to email client 112 and store the DELE command in pipeline command queue 312.

Assume that a QUIT command is received (act 480). POP proxy 310 may transmit all the DELE commands stored in pipeline command queue 312 to mail server 150, followed by the QUIT command (act 480). POP proxy 310 may receive the DELE responses and QUIT response from mail server 150. POP proxy 310 may then discard the corresponding pipelined DELE commands in pipeline command queue 312. After all the DELE responses have been received and their corresponding commands discarded from pipeline command queue 312, POP proxy 310 may forward the QUIT command response to email client 112 (act 480). POP proxy 310 may then close the connections to email client 112 and mail server 150. In this manner, email client 112 receives immediate notification regarding a DELE command and does not have to wait until the DELE response is actually received from mail server 150.

In addition, in alternative implementations, DELE commands may be sent to server 150 after a predetermined number of DELE commands have been received or when pipeline command queue 312 is full. In either case, POP proxy 310 may wait until a number of DELE commands have been received and then send the DELE commands together to mail server 150. This reduces overhead associated with individually transmitting DELE commands to mail server 150. POP proxy 310 may also wait until responses to all the DELE commands have been received before sending the QUIT command to mail server 150.

In other alternative implementations, the DELE commands may be sent to mail server 150 along with other commands as the need to send the other commands arises. In still other implementations, POP proxy 310 may send the DELE commands to mail server 150 as they arrive.

POP proxy 310, as discussed above, forms connections with email client 112 and mail server 150. POP proxy 310, consistent with the present invention, may operate in accordance with a finite state machine model that involves creating a connection to mail server 150, receiving commands from email client 112, sending commands to mail server 150, receiving responses from mail server 150 and sending responses to email client 112.

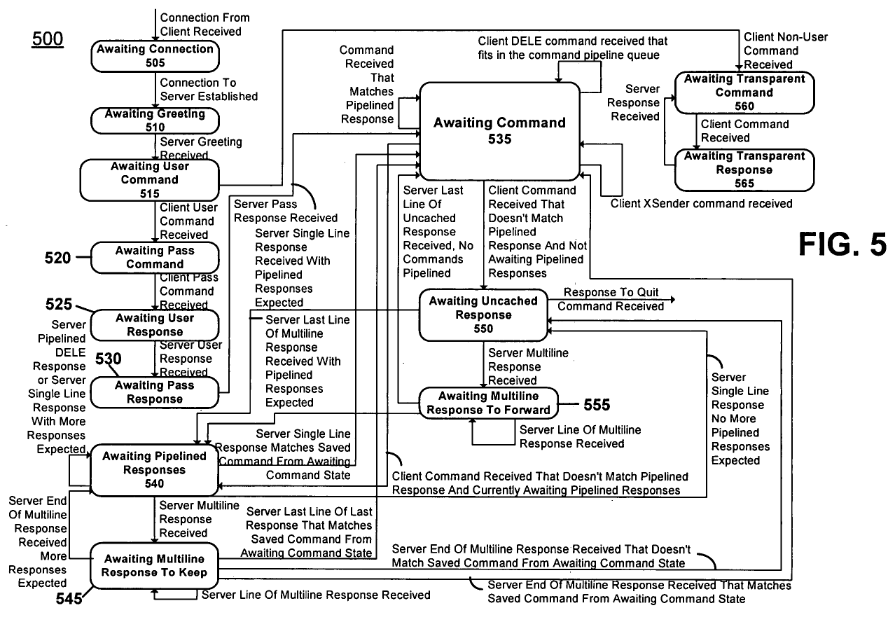

FIG. 5 is an exemplary finite state machine diagram 500 illustrating exemplary processing by POP proxy 310 in accordance with an implementation of the present invention. The operation of finite state machine 500 may begin by POP proxy 310 accepting a connection request from email client 112. POP proxy 310 may then initiate a connection to mail server 150. Referring to FIG. 5, finite state machine 500 includes the following states: Awaiting Connection state 505, Awaiting Greeting state 510, Awaiting User Command state 515, Awaiting Pass Command state 520, Awaiting User Response state 525, Awaiting Pass Response state 530, Awaiting Command state 535, Awaiting Pipelined Responses state 540, Awaiting Multiline Response to Keep state 545, Awaiting Uncached Response state 550, Awaiting Multiline Response to Forward state 555, Awaiting Transparent Command state 560 and Awaiting Transparent Response state 565. These states are described in detail below.

Awaiting Connection state 505—in this state, POP proxy 310 may wait for the establishment of a connection to mail server 150. If the connection to mail server 150 fails, POP proxy 310 may send a −ERR Server Unreachable response to email client 112. POP proxy 310 may also gracefully close the connection to email client 112. When the connection to mail server 150 is established, POP proxy 310 may enter the Awaiting Greeting state 510.

Awaiting Greeting state 510—in this state, POP proxy 310 may wait for the greeting from mail server 150. When the greeting is received, POP proxy 310 may relay the greeting to email client 112 and transition to the Awaiting User Command state 515. If a connection failure occurs or an invalid response from mail server 150 is received, POP proxy 310 may send an −ERR Invalid Server Hello response to email client 112. POP proxy 310 may also gracefully close the connection to email client 112. POP proxy 310 may also close (gracefully or ungracefully) the connection to mail server 150.

Awaiting User Command state 515—in this state, POP proxy 310 may wait for a USER command from email client 112. If anything other than a USER command is received, POP proxy 310 may forward it to mail server 150 and switch to the Awaiting Transparent Command state 560. When the USER command is received, POP proxy 310 may reply immediately with a +OK response and switch to the Awaiting Pass Command state 520. If a connection failure occurs, POP proxy 310 may close both connections (i.e., the connections to email client 112 and mail server 150).

Awaiting Pass Command state 520—in this state, POP proxy 310 may wait for a PASS command from email client 112. When the PASS command is received, POP proxy 310 may forward the command to mail server 150 along with the USER command and pipelined STAT and LIST commands. POP proxy 310 may send the commands to mail server 150 in the original order (i.e., USER, PASS, STAT and then LIST) and store the commands in a pipeline queue (e.g., pipeline command queue 312). POP proxy 310 may also transition to the Awaiting User Response state 525. If anything other than a PASS command is received, POP proxy 310 may send a −ERR Pass Expected response to email client 112 and gracefully close both connections.

Awaiting User Response state 525—in this state, POP proxy 310 may wait for a response to the USER command from mail server 150. If anything other than a +OK response is received, POP proxy 310 may forward it to email client 112 and may close the connection to email client 112 and mail server 150. If a +OK response is received, POP proxy 310 may transition to the Awaiting Pass Response state 530. If a connection failure occurs, POP proxy 310 may close both connections.

Awaiting Pass Response state 530—in this state, POP proxy 310 may wait for a response to the PASS command. The response may be relayed to email client 112. If anything other than a +OK response is received, POP proxy 310 may close the connection to email client 112 and the connection to mail server 150. If a +OK response is received, POP proxy 310 may enter the Awaiting Command state 535. If a connection failure occurs, POP proxy 310 may close both connections.

Awaiting Command state 535—in this state, POP proxy 310 may wait for a command from email client 112. The processing in this state may be as follows:
a) when the command is a command for which there is a cached response (e.g. STAT, LIST or RETR), POP proxy 310 replies from its cache (e.g., response buffer 314) and removes the entry from response buffer 314.
b) when the command is a DELE command and the pipeline command queue 312 is not full, POP proxy 310 immediately responds with an +OK response and pipelines the DELE command, both sending it to mail server 150 and storing it in the pipeline command queue 312.
c) when the command is an XSENDER command, POP proxy 310 rejects the command with a −ERR Invalid Command response.
d) when either the DELE command does not fit or the command is not an XSENDER command and the command has no cached response and the pipeline command queue 312 is empty, POP proxy 310:
   1) sends the command to mail server 150 and saves a copy of the command;
   2) fills the pipeline with RETR commands. These RETR commands may include incrementing message numbers starting with either 1 or 1 greater than the previous RETR command sent to mail server 150. Such commands may be pipelined by sending them to mail server 150 and placing them into the pipeline command queue 312. The pipeline is full when either the total size of all pipelined responses exceeds the response buffer 314 capacity, when the pipeline command queue's 312 maximum number of pipelined commands is reached or when the LIST command response indicates that there are no further messages to be retrieved; and
   3) transitions to the Awaiting Uncached Response state 550.
e) when either the DELE does not fit or (the command is not an XSENDER command and the command has no cached response) and the pipeline command queue 312 is not empty, POP proxy 310:
   1) saves a copy of the command; and
   2) transitions to the Awaiting Pipelined Responses state 540.
f) should a valid command line not be receivable or should the connection to client 112 fail, POP proxy 310 closes both connections.

Awaiting Pipelined Responses state 540—in this state, POP proxy 310 may wait for a response line from mail server 150. When the response line is received, POP proxy 310 may remove the front entry from pipeline queue command queue 312, analyze both the response line and the command which it is in response to and determines whether this is a single-line response, a multi-line response or a response to a pipelined DELE command. The processing of each of these cases may be as follows:
a) Single-Line Response—POP proxy 310 puts the response into the response buffer 314 and looks up the previously received command saved in the Awaiting Command state 535. When the lookup succeeds, POP proxy 310 sends the cached response to email client 112, removes the entry from pipeline command queue 312 and transitions to the Awaiting Command state 535. When the lookup fails, POP proxy 310 checks whether the pipeline command queue 312 is empty (whether any other pipelined responses are expected). If more responses are expected, POP proxy 310 stays in the Awaiting Pipelined Responses state 540. If no more responses are expected, POP proxy 310 sends the saved command to mail server 150 and transitions to the Awaiting Uncached Response state 550.
b) Multi-Line Response—POP proxy 310 puts the first line of a response into response buffer 314 and transitions to the Awaiting Multi-Line Response To Keep state 545.
c) Pipelined DELE Response—POP proxy 310 discards the response and checks whether the pipeline command queue 312 is empty. If not empty, POP proxy 310 stays in the Awaiting Pipelined Responses state 540. If empty, POP proxy 310 sends the saved command to mail server 150 and transitions to the Awaiting Uncached Response state 550.

Awaiting Multiline Response To Keep state 545—in this state, POP proxy 310 may wait for a line of text from mail server 150. If the line is not the end of message line (i.e., a period followed by CRLF), POP proxy 310 may append the line to the current response's cache entry and remain in the Awaiting Multiline Response To Keep state 545. If the line is an end-of-message line, POP proxy 310 may append the line to the current response's cache entry. POP proxy 310 may then do a cache lookup for the previously saved command. If the cache lookup succeeds, POP proxy 310 may send the cached response to email client 112 (removing it from response buffer 314) and transition to the Awaiting Command state 535. If the cache lookup fails, POP proxy 310 may check whether the pipeline command queue 312 is empty (i.e., whether more pipelined responses are expected.) If not empty, POP proxy 310 may transition into the Awaiting Pipelined Responses state 540. If empty, POP proxy 310 may send the saved command to mail server 150 and transition to the Awaiting Uncached Response state 550.

Awaiting Uncached Response State 550—in this state, POP proxy 310 may wait for a response to the uncached command from mail server 150. When the response line is received, POP proxy 310 may analyze both the response line and the command which it is in response to and determine whether this is a single-line response or a multi-line response. The processing of each of these cases may be as follows:
a) Single-Line Response—POP proxy 310 sends the response to email client 112 and transitions to the Awaiting Command state 535. If the response is to a QUIT command, POP proxy 310 closes both connections.
b) Multi-Line Response—POP proxy 310 puts the first line of response into response buffer 314 and transitions to the Awaiting Multiline Response To Forward state 555.

Awaiting Multiline Response To Forward state 555—in this state, POP proxy 310 may wait for a line of text from mail server 150. If the line is not the end of message line (i.e., a period followed by CRLF), POP proxy 310 may forward the line to email client 112 and remain in the Awaiting Multiline Response To Forward state 555. If the line is an end-of-message line, POP proxy 310 may forward the line to email client 112 and transition to the Awaiting Command state 535. POP proxy 310 may also close both connections when the line of text cannot be properly received, either due to invalid formatting or connection failure.

Awaiting Transparent Command state 560—in this state, POP proxy 310 may wait for a command from email client 112. When a command is received, POP proxy 310 may relay it to mail server 150 and transition to the Awaiting Transparent Response State 565.

Awaiting Transparent Response state 565—in this state, POP proxy 310 may wait for a response from mail server 150. When the response is received, POP proxy 310 may forward it to email client 112 and transition to the Awaiting Transparent Command State 560.

As described above, POP proxy 310 may perform processing according to the finite state machine 500 to establish connections with email client 112 and mail server 150. POP proxy 310, consistent with the present invention, may perform standard TCP server type processes associated with establishing and maintaining these connections. For example, POP proxy 310 may include a listen thread which listens for connections. Upon receiving a connection, POP proxy 310 may spawn a thread to handle the connection. POP proxy 310 may implement the listen thread via an object implemented in, for example, the C++ programming language. A separate C++ object may be used to implement the connection thread that will be used to handle each active connection. The connection thread works with the object's data structures to execute state machine 500 described above. POP proxy 310 may also keep a list of the connection objects which are currently running. This allows POP proxy 310 to stop those connections should a shutdown become necessary.

Various objects may be used to facilitate the processing described above. For example, the pipeline stored in pipeline command queue 312, as discussed above, may contain an entry for each pipelined command that has been sent to mail server 150 and has not yet had a response returned. The entry may identify the command (e.g., STAT, LIST or RETR) and the optional message number associated with the command. The entry may also contain an estimate of the size of the expected response. An object executed by POP proxy 310 may maintain the total size of all expected pipelined responses. This object may be created with a compile time maximum number of entries. Pipelining may also be suspended when pipelining a command would cause either the total size of the expected responses to exceed a configurable value, which is less than response buffer 314's capacity or the maximum number of entries would be exceeded.

Response buffer 314, as described above, may include responses for pipelined commands. Response buffer 314, consistent with the present invention, may be a first in first out (FIFO) buffer of pre-fetched responses for STAT, LIST and RETR commands. The responses themselves may be stored in a configurable sized circular queue. Another circular queue, referred to as the response index, may be used to hold index entries for the responses themselves. For example, an index entry may contain a command identifier (ID), such as one of STAT, LIST or RETR. An index entry may also include an identifier of a message number associated with the response and an index into response buffer 314 indicating where the response starts. An index entry may further include an indication of the size of the response.

When a new response to non-DELE pipelined command arrives from mail server 150, front entries from response buffer 314 are removed as needed to make room for the new responses. A cache lookup may take place by doing a linear search through the response index for a match. When an item is read from the response buffer 314, it is marked for deletion. If the entry is a front entry, the front entry and any immediately following entries that are marked for deletion may be removed from response buffer 314.

POP proxy 310 may also be configurable based on the particular user's requirements. For example, the maximum number of simultaneous POP3 connections to be handled by POP proxy 310 may be configured in accordance with particular user requirements. In one implementation, switch 340 may be configured to switch no more than two POP3 connections simultaneously.

Further, the size of response buffer 314 (in bytes) may be configured based on particular memory constraints and other factors. In one implementation, the size of response buffer 314 may be 100 Kbytes. The throughput of pre-fetched email may be limited to this value divided by the round-trip time. For example, when response buffer 314 has a size of 100 Kbytes, the throughput may be approximately 800 Kbps, based on the location of terminal 110. It should be understood that if the size of response buffer 314 is larger, the throughput may increase since more commands may be sent together to mail server 150 and their corresponding responses stored in response buffer 314. In addition, POP proxy 310 may be preconfigured with the Domain Name of the mail server associated with the particular client and the destination port number to be used when contacting the mail server.

### Conclusion

Systems and methods consistent with the present invention accelerate the retrieval of data from a server by anticipating commands and pre-fetching data based on the anticipated commands. The anticipated command(s) may be transmitted to the server prior to receiving response(s) to earlier command(s). The pre-fetched data may then be stored. When an email client forwards one of the anticipated commands, the stored data may be forwarded to the email client. This provides an efficient manner of retrieving data over relatively long latency links.

For example, if ten messages stored on mail server 150 need to be retrieved and later deleted, the email retrieval response time may be reduced by a factor of ten or more. More specifically, the response time may be reduced from about two round trips per message plus the message transfer time to about 0.1 round trips per message plus the message transfer time, when ten messages are retrieved and later deleted.

The foregoing description of preferred embodiments of the present invention provides illustration and description, but is not intended to be exhaustive or to limit the invention to the precise form disclosed. Modifications and variations are possible in light of the above teachings or may be acquired from practice of the invention. For example, while series of acts have been described with respect to FIGS. 4 and 5, the order of the acts may be modified in other implementations consistent with the present invention. Moreover, non-dependent acts may be performed in parallel.

In addition, the present invention has been described with respect to retrieving email messages from a POP3 server over satellite links. It should be understood that the techniques described herein may be applicable to retrieving other types of data over other types of links. Lastly, certain portions of the invention have been described as being performed by logic, a logic device, a processor or processing logic. Logic, a logic device, a processor and/or processing logic may include hardware, such as an ASIC or field programmable gate array, software executed by a processor or microprocessor, or a combination of hardware and software.

No element, act, or instruction used in the description of the present application should be construed as critical or essential to the invention unless explicitly described as such. Also, as used herein, the article “a” is intended to include one or more items. Where only one item is intended, the term “one” or similar language is used.

The scope of the invention is defined by the claims and their equivalents.

1. A system, comprising:
at least one logic device configured to:
receive a first command from a client for retrieving an electronic mail (email) message stored on a server,
transmit the first command to the server, and
transmit at least one additional command to the server, the at least one additional command being transmitted without additional input from the client and being based on the first command.

2. The system of claim 1, wherein the first command and the at least one additional command comprise post office protocol (POP) 3 retrieval commands.

3. The system of claim 1, wherein the first command comprises a command for retrieving a first email message stored on the server and the at least one additional command comprises a second command for retrieving a second email message stored on the server.

4. The system of claim 3, further comprising:
a memory configured to store responses from the server.

5. The system of claim 4, wherein the at least one logic device is further configured to:
receive the second command from the client,
determine whether a response to the second command is stored in the memory, and
forward, from the memory, the response to the second command to the client when the response is stored in the memory.

6. The system of claim 5, wherein the at least one logic device is further configured to:
wait until the response to the second command is received from the server, when the response is not stored in the memory, and
forward the response to the second command to the client after the response to the second command is received.

7. The system of claim 1, wherein the at least one logic device is further configured to:
receive a log in related command from the client,
transmit the log in related command to the server, and
transmit at least one of a statistics related command and a list related command to the server without further input from the client.

8. The system of claim 7, wherein the log in related command comprises a command for transmitting a password, the statistics related command comprises a command for retrieving information indicating a number of messages waiting to be retrieved from the server and the list related command comprises a command for retrieving information regarding a size of each message waiting to be retrieved from the server, and wherein when transmitting at least one of the statistics related command and list related command, the at least one logic device is configured to:
transmit the statistics related command and the list related command to the server without further input from the client.

9. The system of claim 7, further comprising:
a memory configured to store information received from the server; wherein the at least one logic device is further configured to:
transmit the statistics related command and the list related command to the server,
receive responses to the statistics related command and the list related command,
store the responses in the memory, and
forward the respective responses to the statistics related command and the list related command from the memory to the client, in response to receipt of the statistics related command and list related command from the client.

10. The system of claim 1, wherein the at least one logic device is configured to transmit the first command and the at least one additional command via a satellite link.

11. The system of claim 1, wherein the at least one logic device and the client are implemented in a same terminal device.

12. A method for retrieving data, comprising:
receiving a first command from an email client;
transmitting the first command to a server; and
transmitting at least one additional command to the server without additional input from the email client, the at least one additional command comprising a command expected to be received from the email client.

13. The method of claim 12, wherein the first command comprises a command for retrieving a first message stored on the server and the at least one additional command comprises a second command for retrieving a second message stored on the server, the method further comprising:
receiving the second command from the email client;
determining whether a response to the second command is stored in a memory; and
forwarding, from the memory, the response to the second command to the client, when the response is stored in the memory.

14. The method of claim 13, further comprising:
waiting until the response to the second command is received from the server, when the response is not stored in the memory; and
forwarding the response to the second command to the email client after it is received.

15. The method of claim 12, wherein the first command is associated with logging into an account on the server and the at least one additional command comprises at least one of a statistics related command or a list related command, the method further comprising:
receiving responses to the first command and the at least one additional command;
storing the response to the at least one additional command in a memory; and
forwarding the response to the at least one additional command from the memory upon receiving a command corresponding to the at least one additional command from the email client.

16. The method of claim 12, wherein the first command and the at least one additional command are transmitted via a satellite link.

17. The method of claim 12, further comprising:
receiving a plurality of delete commands from the email client;
immediately responding to the email client regarding each of the plurality of delete commands;
storing at least some of the plurality of delete commands in a memory; and
transmitting the stored delete commands to the server.

18. The method of claim 17, further comprising:
receiving a quit command from the email client;
determining whether a response to each of the plurality of delete commands has been received; and
forwarding the quit command to the server after responses to each of the plurality of delete commands has been received.

19. A computer-readable medium having stored thereon a plurality of sequences of instructions which, when executed by at least one processor, cause the at least one processor to:
receive a first command from a client, the first command being associated with accessing electronic mail (email) messages stored on a server;
transmit the first command to the server; and
transmit at least one additional command to the server, the at least one additional command being transmitted without additional input from the client and prior to receiving a response to the first command, where the at least one additional command is based on the first command.

20. The computer-readable medium of claim 19, wherein the first command and the at least one additional command comprise post office protocol (POP) 3 retrieval commands.

21. The computer-readable medium of claim 19, wherein the first command comprises a command for retrieving a first email message stored on the server and the at least one additional command comprises a plurality of commands for retrieving a plurality of additional email messages stored on the server.

22. The computer-readable medium of claim 21, further including instructions for causing the at least one processor to:
receive a response to the first command;
forward the response to the client;
receive responses to at least some of the plurality of commands;
store the received responses to the plurality of commands;
receive a second command from the client;
identify a stored response corresponding to the second command; and
forward the stored response corresponding to the second command to the client.

23. The computer-readable medium of claim 22, further including instructions for causing the processor to:
wait until the response to the second command is received from the server, when the response has not been received; and
forward the response to the second command to the client after it is received.

24. The computer-readable medium of claim 19, wherein the first command is a log in related command and the at least one additional command comprises at least one of a statistics related command for retrieving information indicating a number of email messages waiting to be retrieved from the server or a list related command for retrieving information regarding a size of each email message waiting to be retrieved from the server.

25. The computer-readable medium of claim 24, and wherein when transmitting the at least one additional command to the server, the at least one processor is configured to transmit the statistics related command and the list related command to the server without additional input from the client.

26. The computer-readable medium of claim 25, wherein the least one processor is further configured to:
receive responses to the statistics related command and the list related command;
store the responses; and
forward the respective responses to the statistics related command and the list related command to the client, in response to receipt of the statistics related command and list related command from the client.

27. The computer-readable medium of claim 19, wherein the at least one processor is configured to transmit the first command and the at least one additional command via a satellite link.

28. A system for retrieving data, comprising:
means for receiving a first command from a client, the first command being associated with retrieving data stored on a server;
means for transmitting the first command to the server; and
means for transmitting at least one additional command to the server, the at least one additional command being transmitted without additional input from the client and being based on the first command.

29. The system of claim 28, further comprising:
means for receiving responses to the first command and the at least one additional command;
means for forwarding the response to the first command to the client;
means for storing the received response to the at least one additional command;
means for receiving a second command from the client corresponding to the at least one additional command; and
means for forwarding the stored response to the at least one additional command to the client in response to receiving the second command from the client.

30. A device, comprising:
a transmitter configured to transmit Internet Protocol (IP) data;
a receiver configured to receive IP data; and
logic coupled to the transmitter and receiver, the logic configured to:
receive a first command from an email client for retrieving data,
transmit the first command to a server via the transmitter,
transmit at least one additional command to the server via the transmitter without further input from the email client and the at least one additional command being based on the first command,
receive a response to the first command via the receiver,
forward the response to the email client,
receive a response to the at least one additional command via the receiver,
buffer the response to the at least one additional command, and
forward the buffered response to the at least one additional command to the email client in response to receiving a command from the email client corresponding to the at least one additional command.

31. The device of claim 30, wherein the at least one additional command comprises at least one of a statistics related command, a list related command or a retrieval related command.

32. The device of claim 30, wherein the transmitter is configured to transmit IP data via a satellite link and the receiver is configured to receive IP data via a satellite link.

33. A terminal device configured to transmit and receive data via satellite, comprising:
a memory configured to store data; and
at least one logic device configured to:
receive a first command from a client for retrieving data,
transmit the first command to a server via satellite,
transmit, without further input from the client, at least one additional command to the server via satellite, the at least one additional command being based on the first command,
receive a response to the first command via satellite,
forward the response to the client,
receive a response to the at least one additional command via satellite,
buffer the response to the at least one additional command, and
forward the buffered response to the at least one additional command to the client in response to receiving a command from the client corresponding to the at least one additional command.

34. The terminal device of claim 33, further comprising:
a processor configured to execute an electronic mail program.

35. A system, comprising:
at least one logic device configured to:
receive a first command from a client for retrieving an electronic mail (email) message stored on a server,
transmit the first command to the server, and
transmit at least one additional command to the server, the at least one additional command being transmitted prior to receiving a response to the first command.

36. The system of claim 35, wherein the at least one additional command comprises a plurality of commands transmitted without additional input from the client and being based on the first command.

37. The system of claim 35, where the at least one additional command is transmitted with the first command or in close time proximity to the first command.

38. A satellite terminal, comprising:
a switch configured to:
receive a command associated with electron mail (email) retrieval, and
redirect the command; and
an email retrieval proxy configured to:
receive the redirected command, and
forward the redirected command to an email server.

39. The satellite terminal of claim 38, wherein the switch performs transport layer processing and the email retrieval is performed in accordance with post office protocol version 3.
